(19) United States
(12) Patent Application Publication
(10) Pub. No.: US 2004/0004164 A1
(43) Pub. Date: Jan. 8, 2004

(54) Device for fixing a wire in a computer

(76) Inventor: Yung-Shun Chen, Luju Shiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/294,974

(22) Filed: Nov. 14, 2002

(30) Foreign Application Priority Data
Jul. 5, 2002 (TW) 91210264

(51) Int. Cl. F16L 3/08

(52) U.S. Cl. 248/74.2

(57) ABSTRACT

A device for fixing a wire. The fixing device includes a plurality of fixing clips. Each fixing clip has a first cantilever and a second cantilever. The free end of the first cantilever is separated from that of the second cantilever by a distance to form an opening. The openings of the plurality of fixing clips face a same direction.

### BACKGROUND OF THE INVENTION

1. Field of the Invention

The present invention relates to a device for fixing a wire, and in particular to a device for fixing a wire and preventing electromagnetic interference (EMI).

2. Description of the Related Art

Referring to FIG. 1, a wire 12 is fixed or fastened in a position by a plurality of completely sealed fixing devices 11. When the wire 12 is removed, the completely sealed fixing devices 11 have to be removed completely. Thus, it is inconvenient to remove the wire 12. In addition, instruments connected to the wire 12 may be damaged during removal of the completely sealed fixing devices 11, such that the life span thereof is reduced.

Referring to FIG. 2, laterally fixed clips 23 and 25 have opposite openings. The directions of the openings of the laterally fixed clips are alternately changed. A wire 21 is fit into the laterally fixed clips 23 and 25 having opposite openings in sequence.

Referring to FIG. 3, a part of a wire 31 is fit in the fixing portion of a laterally fixed clip 33 while the other part is located outside a laterally fixed clip 35. The other part of the wire 31 is fit into the fixing portion of the laterally fixed clip 35 by the procedures shown in FIG. 4A, FIG. 4B and FIG. 4C.

As shown in FIG. 4A, the wire 31 is not fit into the fixing portion of the laterally fixed clip 35. As shown in FIG. 4B, the wire 31 is moved to the fixing portion of the laterally fixed clip 35 from the outside of the laterally fixed clip 35. When the wire 31 is pushed to a free end 37 of a resilient cantilever of the laterally fixed clip 35 in the direction of the arrows shown in FIG. 4B, the free end 37 is subjected to compression force. The majority of the compression force is transmitted to a fixed end 39 of the resilient cantilever. When the wire 31 continues to be pushed, the free end 37 and the fixed end 39 are subjected to greater compression force. Specifically, the compression force taken by the fixed end 39 is greater than that taken by the free end 37. Meanwhile, the diameter of the wire 31 is reduced due to the compression force. As shown in FIG. 4C, when the distance between the free end 37 and the fixed end 39 is approximately equal to the diameter of the wire 31, the wire 31 can be fit in the fixing portion of the laterally fixed clip 35.

As shown in FIG. 4D, the wire 31 is removed from the fixing portion of the laterally fixed clip 35 in the direction of the arrows. The free end 37 of the resilient cantilever is subjected to compression force. Meanwhile, the fixed end 39 of the resilient cantilever is subjected to greater compression force. When the distance between the free end 37 and the fixed end 39 is approximately equal to the diameter of the wire 31, the wire 31 can be removed from the fixing portion of the laterally fixed clip 35.

As shown in FIG. 4B and FIG. 4D, the fixed end 39 of the resilient cantilever is subjected to maximum compression force. Thus, the fixed end 39 of the resilient cantilever of the laterally fixed clip 35 is easily damaged, such that the wire 31 cannot be fixed by the laterally fixed clip 35. Furthermore, instruments connected to the wire 31 are possibly damaged. Moreover, when the wire 31 is fit into or removed from the laterally fixed clip 35, powerful friction between the free end 37 of the resilient cantilever and the wire 31 causes wear of the outer layer of the wire 31.

Additionally, the wire 31 is fit into the laterally fixed clips 35 having alternately opposite openings. Similarly, the wire 31 is removed from the laterally fixed clips 35 having alternately opposite openings. Thus, time required for fitting or removing the wire 31 is increased.

FIG. 5A shows another conventional laterally fixed clip 51. When a wire 52 is fit into the laterally fixed clip 51, the laterally fixed clip 51 is subjected to non-uniform downward compression force. Thus, the laterally fixed clip 51 is easily damaged. Additionally, when the wire 52 is fit into or removed from the laterally fixed clip 51, the free end of the cantilever of the laterally fixed clip 51 scrapes the outer surface of the wire 52. Thus, the wire 52 is easily damaged. As well, instruments connected to the wire 52 are easily damaged.

FIG. 5B shows another conventional laterally fixed clip 53. When a wire 54 is fit into the laterally fixed clip 53, the laterally fixed clip 53 is subjected to non-uniform downward compression force as in the case of the laterally fixed clip 51. The fixed end of the resilient cantilever of the laterally fixed clip 53 is easily damaged due to the structure of the laterally fixed clip 53. Similarly, when the wire 54 is fit into or removed from the laterally fixed clip 53, the free end of the cantilever of the laterally fixed clip 53 scrapes the outer surface of the wire 54. Thus, the wire 54 is easily damaged. As well, instruments connected to the wire 54 are easily damaged.

### SUMMARY OF THE INVENTION

An object of the invention is to provide a device for fixing a wire. The fixing device comprises a plurality of fixing clips. Each fixing clip has a first cantilever and a second cantilever. The free end of the first cantilever is separated from that of the second cantilever by a distance to form an opening. The openings of the plurality of fixing clips face a same direction. The wire is fit into or removed from the plurality of fixing clips via the openings. Specifically, since the openings of the plurality of fixing clips face the same direction, the outer layer of the wire is not damaged when the wire is fit into or removed from the plurality of fixing clips.

Preferably, the wire is covered by metal.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a wire fit in a conventional completely sealed fixing device;

FIG. 2 shows a wire fit in a plurality of first conventional laterally fixed clips;

FIG. 3 shows the relation among the wire and two first conventional laterally fixed clips;

FIG. 4A and FIG. 4B show the wire fit into the first conventional laterally fixed clip from outside;

FIG. 4C shows the wire fit in the fixing portion of the first conventional laterally fixed clip;

FIG. 4D shows the wire removed from the fixing portion of the first conventional laterally fixed clip;

FIG. 5A shows a second conventional laterally fixed clip;

FIG. 5B shows a third conventional laterally fixed clip;

FIG. 6 is a first embodiment of the invention showing a wire fit in a plurality of relative fixing clips;

FIG. 7A shows the wire and three relative fixing clips of the first embodiment of the invention;

FIG. 7B shows the wire located at the opening between the two free ends of the two resilient cantilevers of the present relative fixing clip;

FIG. 7C shows the wire located at the opening of the present relative fixing clip;

FIG. 8A is a second embodiment of the invention showing a wire fit in a plurality of relative fixing clips; and

FIG. 8B is a cross section showing a wire covered by metal.

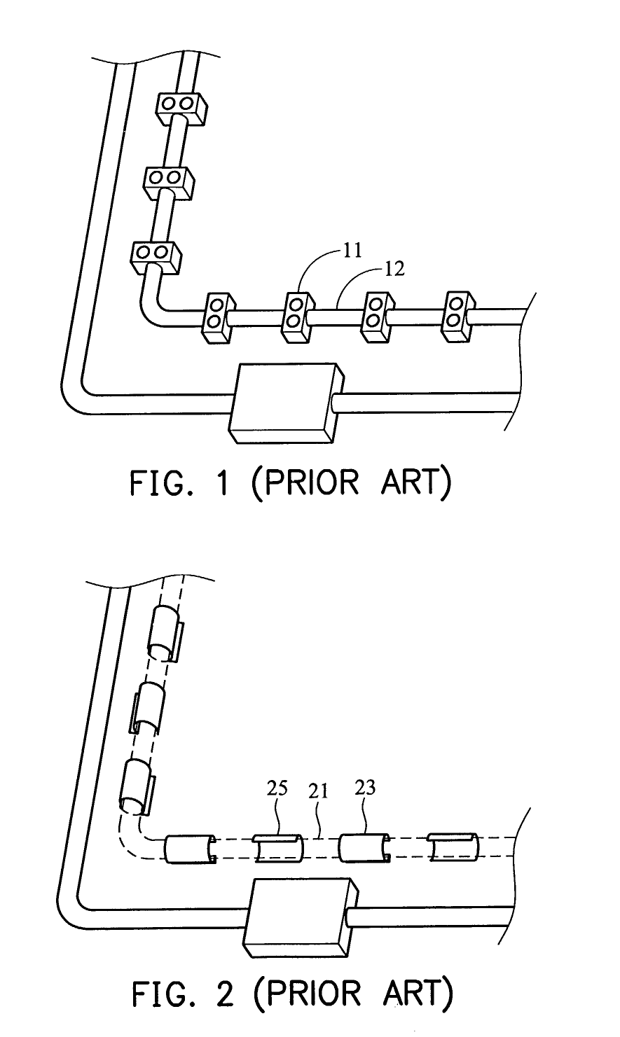

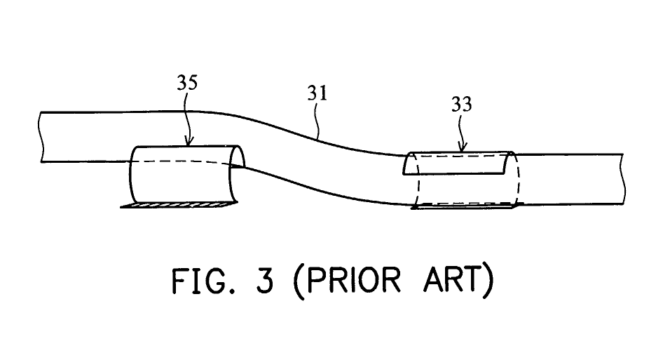

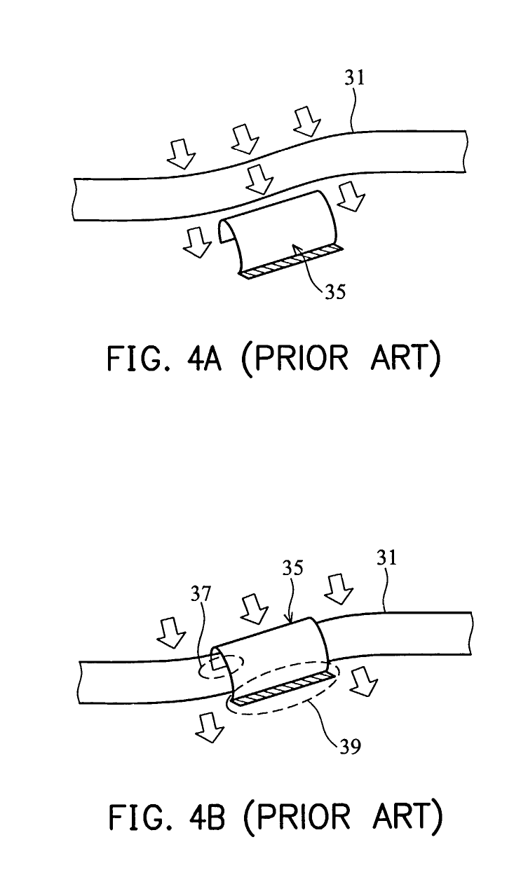

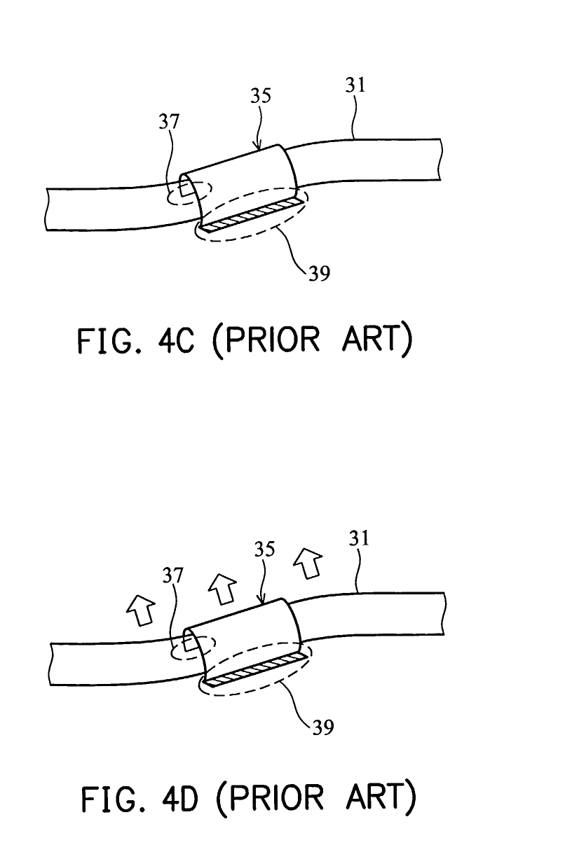

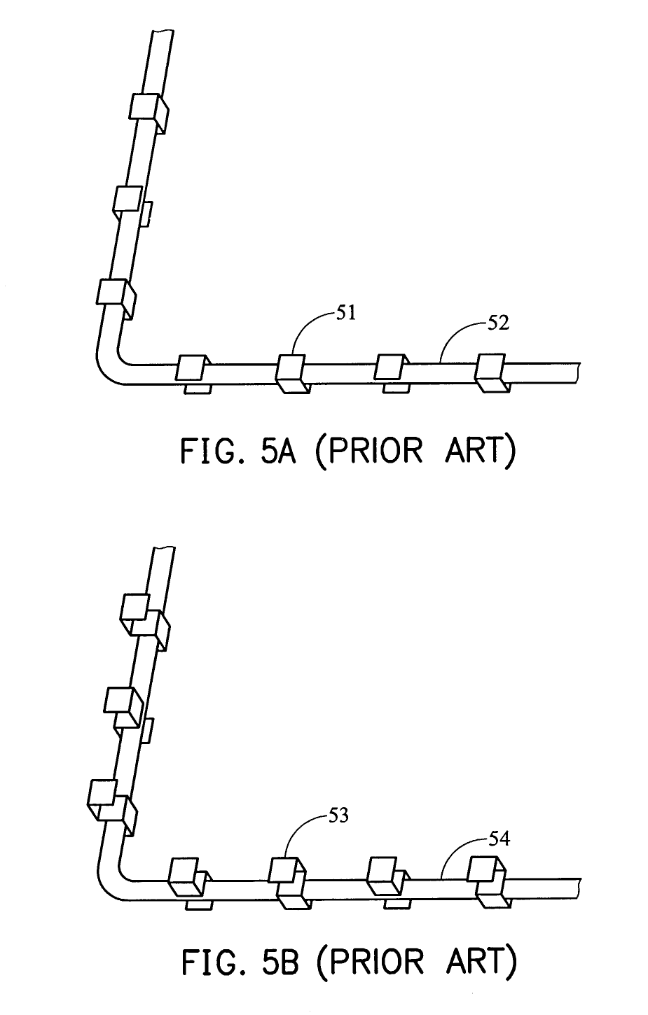

### DETAILED DESCRIPTION OF THE INVENTION

First Embodiment

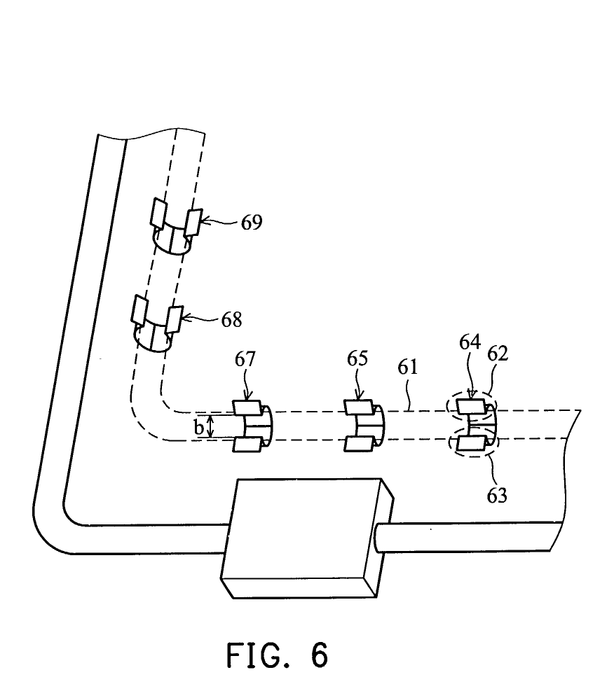

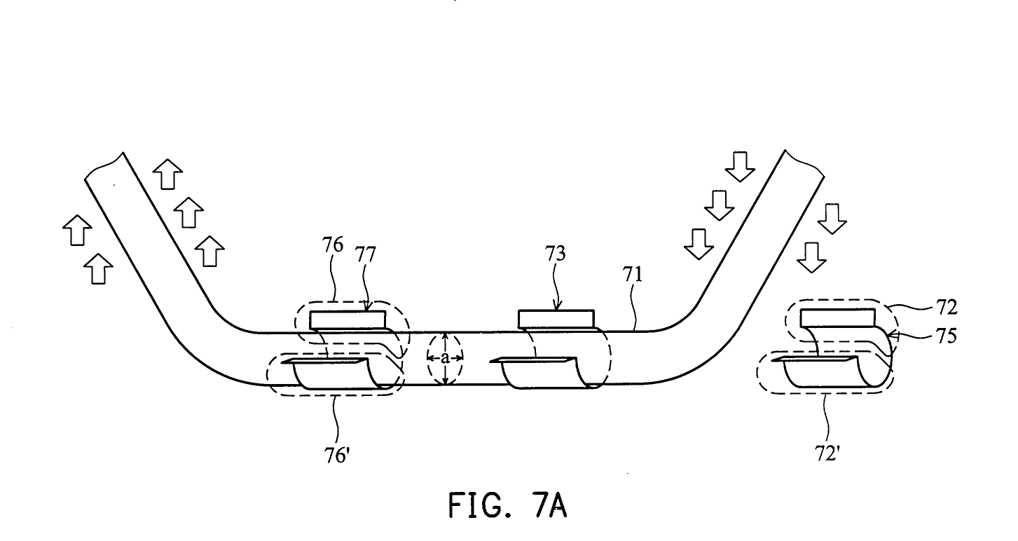

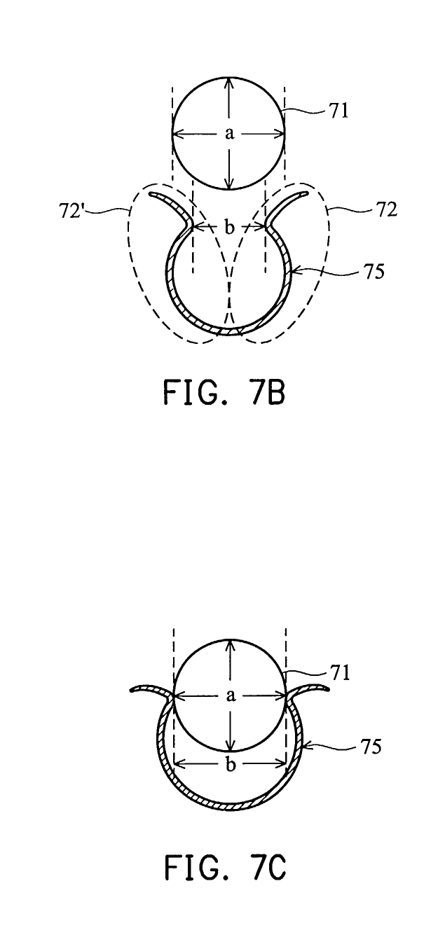

Referring to FIG. 6, the fixing device of the invention comprises a plurality of relative fixing clips 64, 65, 67, 68 and 69 disposed on a plane surface. A wire 61 is fit in the relative fixing clips 64, 65, 67, 68 and 69. Each relative fixing clip has a first resilient cantilever and a second resilient cantilever. The cross sections of the first and second resilient cantilevers are S-shaped. For example, the relative fixing clip 64 has a first resilient cantilever 62 and a second resilient cantilever 63. The free end of the first resilient cantilever 62 is separated from that of the second resilient cantilever 63 by a distance b to form an opening, as shown in FIG. 7B. The openings of the relative fixing clips 64, 65, 67, 68 and 69 face a same direction. In this embodiment, the direction is perpendicular to the plane surface. The wire 61 is fit into and removed from the fixing portions of the relative fixing clips 64, 65, 67, 68 and 69 via the openings thereof.

Referring to FIG. 7A, a part of a wire 71 having a diameter a is fit in the fixing portion of relative fixing clip 73. One end of the wire 71 is fit into the fixing portion of the relative fixing clip 75 in the direction shown by downward arrows while the other end is removed from the fixing portion of the relative fixing clip 77 in the direction shown by upward arrows. The relative fixing clip 75 has a first resilient cantilever 72 and a second resilient cantilever 72′. The relative fixing clip 77 has a first resilient cantilever 76 and a second resilient cantilever 76′. The cross sections of the first resilient cantilever 72, the second resilient cantilever 72′, the first resilient cantilever 76 and the second resilient cantilever 76′ are S-shaped.

Referring to FIG. 7B, before the wire 71 is fit into the fixing portion of the relative fixing clip 75, the diameter a of the wire 71 is slightly greater than the width b of the opening of the relative fixing clip 75. As shown in FIG. 7C, when the wire 71 is pushed to the opening between the free end of the first resilient cantilever 72 and that of the second resilient cantilever 72′ from the upper outside of the relative fixing clip 75, the width b of the opening is slightly greater than the diameter a of the wire 71. Thus, the wire 71 can be fit into the fixing portion of the relative fixing clip 75 smoothly. The compression force generated among the wire 71, the free ends of the first and second resilient cantilevers 72, 72′ is taken by the fixed ends of the first and second resilient cantilevers 72, 72′. Since the compression force taken by each fixed end of the relative fixing clip 75 is tremendously reduced compared to that taken by the only fixed end of the conventional laterally fixed clip, the relative fixing clip 75 is not easily damaged. Furthermore, instruments and the wire 71 connected thereto are not easily damaged.

As shown in FIG. 7A, a part of the wire 71 is fit in the fixing portion of the relative fixing clip 77. The wire 71 can be removed from the relative fixing clip 77 in the direction shown by the upward arrows and via the opening between the free ends of the first and second resilient cantilevers 76, 76′. When the width b of the opening is slightly greater than the diameter a of the wire 71, the wire 71 passes through the opening and is removed from the fixing portion of the relative fixing clip 77 smoothly. Similarly, the compression force generated among the wire 71 and the free ends of the first and second resilient cantilevers 76, 76′ is taken by the fixed ends of the first and second resilient cantilevers 76, 76′. Since the compression force taken by each fixed end of the relative fixing clip 75 is tremendously reduced compared to that taken by the only fixed end of the conventional laterally fixed clip, the relative fixing clip 77 is not easily damaged. Furthermore, instruments and the wire 71 connected thereto are not easily damaged.

Accordingly, when the wire is fit into the fixing portion of the relative fixing clip, the compression force is taken by two sides of the wire. Thus, the wire is not easily scraped or damaged. In addition, because the openings of the relative fixing clips face a same direction, it is convenient for the wire to be fit into and removed from the relative fixing clips.

Second Embodiment

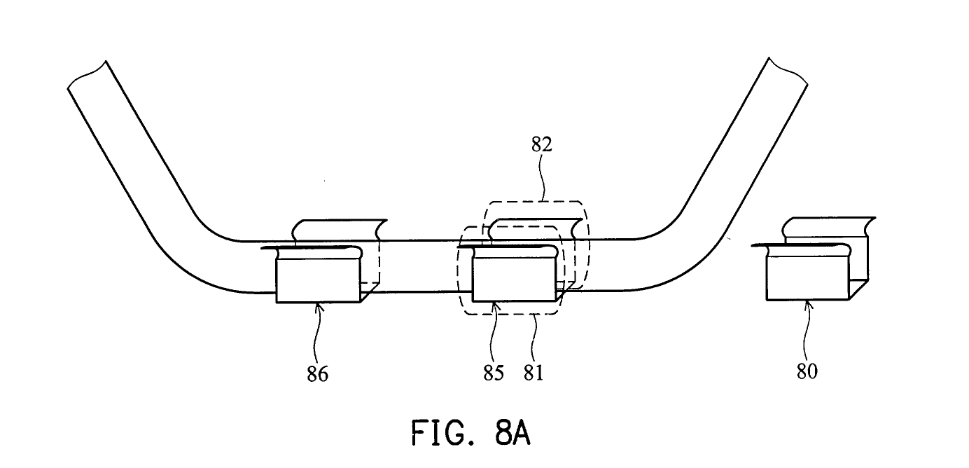

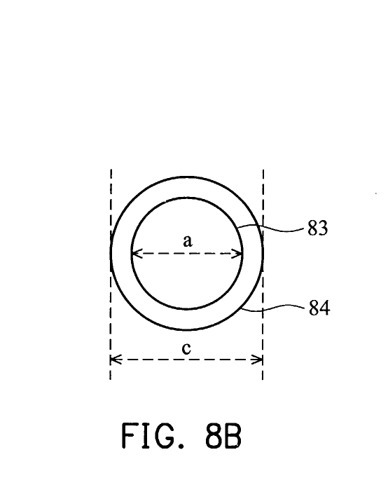

Referring to FIG. 8A, the fixing device comprises a plurality of relative fixing clips 80, 85 and 86 disposed on a plane surface. Each relative fixing clip has a first resilient cantilever and a second resilient cantilever. The cross sections of the first and second resilient cantilevers are composed of a U-shaped portion and a linear portion. For example, the relative fixing clip 85 has a first resilient cantilever 81 and a second resilient cantilever 82. The free end of the first resilient cantilever 81 is separated from that of the second resilient cantilevers 82 by a distance to form an opening. The openings of the relative fixing clips 80, 85 and 86 face a direction perpendicular to the plane surface. In this embodiment, the wire is not easily scraped and the fixed ends of the resilient cantilevers are not easily damaged. Thus, time required for fitting or removing the wire is reduced and reliability thereof is enhanced.

Referring to FIG. 8B, in order to prevent electromagnetic interference (EMI), a wire 83 is covered by a metal layer 84. The metal layer 84 can be copper or aluminum. In addition, the relative fixing clip can also be welded on a printed circuit board (PCB) and electrically connected to a metal protrusion on the PCB to prevent EMI. When the width b of the opening of the relative fixing clip is greater than the diameter c of the wire 83 in combination with the metal layer 84, the wire 83 in combination with the metal layer 84 can be fit into the fixing portion of the relative fixing clip smoothly. Specifically, because of the metal layer 84, surface wear of the wire 83 is reduced and tightness between the wire 83 and the relative fixing clip is enhanced. Thus, the contact force between the wire 83 and the relative fixing clip is much more stable and the wire 83 is not easily damaged under any condition.

To conclude, the invention has the following advantages.

(1) The life span of the fixing clip is increased.

(2) The wire fit in the fixing clip is not easily damaged.

(3) The life span of the instruments connected to the wire is increased.

(4) It is convenient to fit the wire into the fixing clip.

While the invention has been described by way of examples and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device for fixing a wire, comprising:
a plurality of fixing clips, each fixing clip having a first cantilever and a second cantilever, wherein the free end of the first cantilever is separated from that of the second cantilever by a distance to form an opening, and the openings of the plurality of fixing clips face a same direction.

2. The device as claimed in claim 1, further comprising a metal cladding covering the wire.

3. The device as claimed in claim 1, wherein the wire is made of a resilient material.

4. A device for fixing a wire, comprising:
a plane surface; and
a plurality of fixing clips disposed on the plane surface, each fixing clip having a first body, a first cantilever connecting the first body, a second body and a second cantilever connecting the second body, the first and second bodies extending from the plane surface, wherein the free end of the first cantilever is separated from that of the second cantilever by a distance to form an opening, and the openings of the plurality of fixing clips face a same direction.

5. The device as claimed in claim 4, wherein the cross sections of the first and second cantilevers are S-shaped.

6. The device as claimed in claim 4, wherein the cross sections of the first and second cantilevers are composed of a U-shaped portion and a linear portion.

7. The device as claimed in claims 5 and 6, wherein the width of the opening is smaller than a distance between the first and second bodies for fixing the wire.

8. The device as claimed in claim 4, wherein the direction faced by the openings of the plurality of the fixing clips is perpendicular to the plane surface.

9. The device as claimed in claim 4, wherein the wire is made of a resilient material.

10. The device as claimed in claim 4, further comprising a metal cladding covering the wire.
